(19) United States
(12) Patent Application Publication
(10) Pub. No.: US 2023/0104294 A1
(43) Pub. Date: Apr. 6, 2023

(54) Dynamic Wardrobe System And Method

(71) Applicant: Sofia Minvielle Dabdoub, New York, NY (US)

(72) Inventor: Sofia Minvielle Dabdoub, New York, NY (US)

(21) Appl. No.: 17/958,782

(22) Filed: Oct. 3, 2022

Related U.S. Application Data
(60) Provisional application No. 63/251,553, filed on Oct. 1, 2021.

(51) Int. Cl. G06Q 30/02; G06Q 30/06

(52) U.S. Cl. CPC G06Q 30/0283; G06Q 30/0643; G06Q 30/0621

(57) ABSTRACT

The present disclosure presents systems and methods that provide personalized information to help individuals optimize the contents their wardrobe in a dynamic manner. The digital wardrobe application can enhance consumers' experience and decision process around what to buy, wear, and sell by proposing a digital wardrobe that can provide information on 1) the number of incremental outfits the user could build with a new given item of clothing, 2) the usage rates of the a garment, 3) the resale value of the item of clothing, 4) the environmental impact of the clothing, and 5) the ability to connect the digital wardrobe across third parties. Through such information, individuals can be better able to optimize the clothes that they buy and own while maximizing the value and environmental impact of the entirety of their wardrobes (thereby reducing overall spend and waste).

### CROSS-REFERENCE TO RELATED APPLICATIONS

The present application claims priority to U.S. Provisional Patent Application No. 63/251,553, titled “DYNAMIC WARDROBE SYSTEM AND METHOD,” and filed Oct. 1, 2021, the entirety of which is incorporated by reference herein.

### TECHNICAL FIELD

The present disclosure relates generally to a digital wardrobe application. More specifically, embodiments of the present invention relate to systems and methods for providing dynamic and adaptive conditions for a selected garment with a listing of garments included in a digital wardrobe system and/or application.

### BACKGROUND

The following description includes information that may be useful in understanding the present disclosure. It is not an admission that any of the information provided herein is prior art or relevant to the presently claimed invention, or that any publication specifically or implicitly referenced is prior art.

Individuals are all different and are constantly subjected to change. Individual's bodies are different and can change with time. Further, each individual can have a unique style that evolves as various trends and the weather change. With the unique nature of each individual, each person has a distinct set of articles of clothing in their possession.

Although individuals interact with their wardrobe every day, they may not know which or how many garments are in their possession. Further considerations, such as what garments are used most consistently, what is the environmental impact of various garments, or a value of the garments, can be used to optimize shopping and selling decisions in order to optimize the contents of the wardrobe.

### SUMMARY

The present disclosure presents systems and methods that provide personalized information to help individuals optimize the contents their wardrobe in a dynamic manner. For example, a user device can implement a digital wardrobe application that can manage garments associated with a user. The digital wardrobe application can enhance consumers' experience and decision process around what to buy, wear, and sell by proposing a digital wardrobe that can provide information on 1) the number of incremental outfits the user could build with a new given item of clothing 2) the usage rates of the clothes found in their wardrobes and 3) the resale value of the item of clothing 4) the environmental impact it generates 5) the ability to connect the digital wardrobe across third parties, and 6) the applicability of an specific version for Metaverse. Through such information, individuals can be better able to optimize the number of clothes they buy and own while maximizing the value of their wardrobe (thereby reducing overall spend, waste and environmental impact).

In a first example embodiment, a computer-implemented method to implement a digital wardrobe application is provided. The method can include detecting a selection of a first garment as the entry point to the digital wardrobe system.

The method can also include retrieving data relating to the first garment from a third-party server. The data relating to such garment can include information about a garment type, a garment color, and an image of the first garment.

In some instances, the retrieving of the data relating to the first garment further includes: transmitting a request to a purchasing platform server requesting the data relating to the first garment, and receiving, from the purchasing platform server, the data relating to the first garment.

The method can also include assigning one or more categories to the first garment using the data relating to the garment. The one or more categories can categorize the first garment at least by garment type. The resulting wardrobe will categorize and organize the aggregate of the individual's apparel belongings, including the first garment.

The method can also include determining a total number of combinations of garments by garment type capable of being combined with the first garment.

The method can also include filtering the total number of combinations of garments to a subset of incremental combinations of garments as combinations of garments that each correspond with rules in a ruleset.

In some instances, the rules in the ruleset specify garment color categories of each garment type that are permitted to be combined. In some instances, the method further comprises retrieving, from one or more third-party servers, environmental data relating to the first garment. The environmental data can specify a listing of materials in the first garment, an amount of water used in producing the first garment, an amount of pollutants emitted in producing the first garment, and a lifespan of the first garment. For example, an environmental rating derived by environmental data can be based on a category of the garment (e.g., jeans) and/or a material of the garment (e.g., denim). The method can also include generating an environmental rating for the first garment and causing display of the environmental rating.

In some instances, the method further comprises tracking a usage of any garment comprising each instance that the first garment is identified as being worn and causing display of the usage of the any garment. In some instances, tracking the usage of a given garment comprises receiving, by a device (including and not limited to; phones, sensors, video nodes, nano-nodes, a blockchain-implemented node, spectral imaging, etc.) disposed within a wardrobe or on the garment itself (including but not limited to nano-sensors), an indication that the garment is being worn. The usage of the garment can be modified to account for the use of the garment responsive to receiving the indication from the sensor that the garment is being worn.

In some instances, the method further comprises retrieving, from one or more third-party servers, resale data for the first garment specifying resale values for garments similar to the first garment, generating a resale value range for the first garment, and causing display of the resale value range. In some instances, the method further comprises storing the data relating to any garment and/or the one or more categories to it in a cloud-based and/or a blockchain-implemented series of interconnected systems.

The method can also include causing display of the image of the first garment and the subset of incremental combinations of garments. In some instances, the method further comprises causing display of an image of a first incremental combinations of garments of the subset of incremental combinations of garments, detecting a selection to view a second incremental combinations of garments, and causing display of an image of the second incremental combinations of garments of the incremental combinations of garments.

In another example embodiment, a user device is provided. The user device can include a processor and one or more memory nodes comprising instructions that, when executed by the processor, cause the processor to detect a selection of the garment at a digital wardrobe system and or application.

The instructions can further cause the processor to retrieve data relating to the first garment from a purchasing platform server, the data relating to the any garment including any of a garment type, a garment color, and an image of the first garment.

The instructions can further cause the processor to assign one or more categories to the first garment using the data relating to the first garment, the one or more categories categorizing the first garment at least by garment type.

The instructions can further cause the processor to determine a total number of combinations of garments by garment type capable of being combined with the any garment.

The instructions can further cause the processor to filter the total number of combinations of garments to a subset of incremental combinations of garments as combinations of garments that each correspond with rules in a ruleset.

In some instances, the rules in the ruleset specify garment color, materials, seasonality, social event type, categories of each garment type that are permitted to be combined. The instructions can further cause the processor to retrieve, from one or more third-party servers, resale data for the first garment specifying resale values for garments similar to the first garment and environmental data specifying an environmental impact of the first garment.

In some instances, the environmental data specifies a listing of materials in the first garment, an amount of water used in producing the first garment, an amount of pollutants emitted in producing the first garment, and a lifespan of the first garment.

The instructions can further cause the processor to generate a resale value range for the first garment using the resale data.

In some instances, the instructions further cause the processor to track a usage of the first garment comprising each instance that the first garment is identified as being worn and cause display of the usage of the first garment.

In some instances, tracking the usage of the garment comprises receiving, by a sensor disposed within a wardrobe, an indication that the first garment is being worn, wherein the usage of the first garment is modified to account for the use of the garment responsive to receiving the indication from the sensor that the first garment is being worn.

The instructions can further cause the processor to generate an environmental rating for the first garment using the environmental data. The instructions can further cause the processor to cause display of the image of the garment and the subset of incremental combinations of garments, the environmental rating, and the resale value range of the garment.

In some instances, the instructions further cause the processor to cause display of an image of multiple comparable combinations of garments of the subset of incremental combinations of garments, detect a selection to view a second incremental combinations of garments, and cause display of an image of the second incremental combinations of garments of the incremental combinations of garments.

In another example embodiment, a method performed by a user device for implementing a digital wardrobe application is provided. The method can include detecting a selection of a f garment at a digital wardrobe system and/or application.

The method can also include retrieving data relating to the first garment from a purchasing platform server, the data relating to the first garment including any of a garment type, a garment color, and an image of the first garment.

The method can also include determining a number of incremental combinations of garments that include the any garment.

In some instances, the method can include assigning one or more categories to the selected garment using the data relating to the first garment, the one or more categories categorizing the first garment at least by garment type.

In some instances, the method can include determining a total number of combinations of garments by garment type capable of being combined with the first garment, and filtering the total number of combinations of garments to the number of incremental combinations of garments as combinations of garments that each correspond with rules in a ruleset. In some instances, the rules in the ruleset specify garment color categories of each garment type that are permitted to be combined.

In some instances, the method can include tracking a usage of the first garment comprising each instance that the first garment is identified as being worn, wherein tracking the usage of the first garment comprises receiving, by a sensor disposed within a wardrobe, an indication that the first garment is being worn, wherein the usage of the first garment is modified to account for the use of the first garment responsive to receiving the indication from the sensor that the first garment is being worn, and causing display of the usage of the first garment.

The method can also include retrieving, from one or more third-party and/or dynamic wardrobe ecosystem, resale data for the first garment specifying resale values for garments similar to the first garment and environmental data specifying an environmental impact of the first garment.

The method can also include generating a resale value range for the first garment using the resale data.

The method can also include generating an environmental rating for the first garment using the environmental data.

The method can also include causing display of the image of the first garment and the subset of incremental combinations of garments, the environmental rating, and the resale value range of the first garment.

### BRIEF DESCRIPTION OF THE DRAWINGS

The accompanying drawings, which are incorporated in and constitute a part of this specification, exemplify various embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not generally drawn to scale.

FIG. 1 illustrates an example system for implementing a digital wardrobe system and/or application in accordance with certain aspects described herein.

FIG. 2 illustrates an interaction between the user device and the series of interconnected servers in accordance with certain aspects described herein.

FIG. 3 illustrates an example user interface of a user device in accordance with certain aspects described herein.

FIG. 4 is a flow process for adding a new garment to a listing of garments in accordance with certain aspects described herein.

FIG. 5 is a flow process for determining a number of incremental outfits for a new garment in accordance with certain aspects described herein.

FIG. 6 illustrates a flow process for determining a number of incremental outfits that correspond with the new garment in accordance with certain aspects described herein.

FIG. 7 is a flow process for generating an environmental rating for a selected garment in accordance with certain aspects described herein.

FIG. 8 is a flow process for generating usage data for the garment in accordance with certain aspects described herein.

FIG. 9 illustrates an example flow process for generating a resale value range for the selected garment in accordance with certain aspects described herein.

FIG. 10 is a flow process for an example method for implementing a digital wardrobe application in accordance with certain aspects described herein.

FIG. 11 is an illustration of an example networked system in accordance with certain aspects described herein.

FIG. 12 is an illustration of an example computer system in accordance with certain aspects described herein.

### DETAILED DESCRIPTION

The world is becoming increasingly digital. Online shopping is becoming an essential part of consumer's shopping behavior. The greatest benefit that online shopping brings to consumers is helping them to consolidate and navigate millions of shopping options. It also makes shopping more accessible. As a consumer, one can access and view information about products sold on the other side of the world. The quickly evolving online retail space, however, is becoming increasingly disjointed from the physical wardrobe at home. While shopping experiences have become almost fully digital, the digital nature of the experience stops as soon as the product arrives in the home. For example, how many times can one buy an item of clothing online and finding there is nothing to match it with when it arrives to your home?

For example, there are a significant number of shopping websites and applications that seek to improve and simplify the retail shopping space for consumers. Shopping websites can consolidate and curate product offerings from millions of brands, making it easier for consumers to consolidate their shopping options. They also keep track of the clothes that user's buy on their specific websites and use that data to learn about the user's preferences and provide shopping recommendations. These websites, however, only have information about the clothes that individuals buy on their particular site and are limited by the selection of brands and articles that they curate into their selection. This inherently limits the information that shopping platforms can obtain about what is actually found in the individual's wardrobes. Although shopping platforms provide digital shopping solutions for their users, they are unable to obtain a holistic picture of what the combination of individual's physical belongings look like.

Search engine shopping platforms can gather shopping information from a variety of different site sources, allowing consumers to search for a specific article of clothing in one place. For example, consumers can enter the word “brown shoes” on a search engine shopping platform and millions of products will appear, all stemming from different websites. Some of these platforms include a user preference and could probably include other personalization agents, such as upcoming weather conditions in the places they frequent and/or the fashion trends they have at the time. Such platforms, however, are not informed by the clothes that individuals have in their physical wardrobes.

A personal styling platform can provide personalized shopping advice based on individual's style preferences and budget. They also implement a “try before you buy” incentive to allow customers to try the clothing options at home to determine the physical fit. This helps consumers ensure that their online shopping choices fit and match their rest of their clothes. Such services are not pre-emptively informed by the clothes that their customers own, and therefore cannot help determine how their shopping recommendations match with the rest of the customers' clothing options until they arrive in their homes.

Further, in many cases, individuals underutilize the clothes in their wardrobes and can't keep track of the inventory of their clothes resulting in many garments going underutilized. A new scarf may get forgotten at the very back of our wardrobe, never to be used. So how can we make better use of our clothes?

Additionally, in many cases, people overspend on their clothes and there is no solution to help track of the value of inventory or the lifetime cycle of their garments. Research estimates that people may spend 5% of their monthly income on clothing and relate items, which on average amounts to $1,400 to $5,000 US per year. So how can you make the most of that allocated spend?

Fast fashion has allowed individuals to access the latest trends at an economically-reasonable price. However, these items of clothing are often thrown out or forgotten in the back of a wardrobe after a few uses. Although fast fashion seems to provide an economically-friendly solution in the short-run, consumers end up overpaying for these items of clothes. Furthermore, fast fashion has a major impact on the environment. One pair of jeans can use up to 8 gallons of water. Synthetic materials found in clothing end up as plastic microfibers to enter our oceans. Fast-fashion clothing has virtually no resale value due to their poor quality. The lifetime value of such clothing is this much lower than that of a higher-quality but perhaps higher-priced item of clothing. Consumers often end up overpaying for clothes that they don't use or only use a handful of times instead of investing in their wardrobe. The current social environment is calling for a solution that helps consumers to shop, use and eventually re-sell their clothing in an optimized and dynamic fashion.

Accordingly, as discussed above, the existing systems and technologies are primarily focused on pushing items for sale rather than focusing on the real-time upkeep and optimization of individual's wardrobes. The existing systems and technologies are limited, static and do not address or satisfy consumer needs. Accordingly, new innovations are greatly needed.

The present disclosure presents systems and methods that provide personalized information to help individuals optimize the contents their wardrobes in a dynamic manner, providing a dynamic wardrobe system and method. As discussed above, contents of our wardrobe are a result of three factors: what clothes we buy, how we use those clothes, and what we decide to get rid of or re-sell. These three factors are affected by constantly changing fashion trends, individual preferences and physical factors such as location and weight fluctuations. Embodiments of the present system and method enhance consumers' experience and decision process around what to buy, wear and sell by proposing a digital wardrobe that can provide information on 1) the number of incremental outfits the user could build with a new given item of clothing 2) the usage rates of the clothes found in their wardrobes and 3) the resale value of the item of clothing. Through such information, individuals will be better able to optimize the number of clothes they buy and own while maximizing the value of their wardrobe (thereby reducing overall spend and waste).

For example, a digital wardrobe system and/or application can be executing on a user device. The user device can interact with a cloud-based series of interconnected servers to implement processing and storage of data as described herein.

The digital wardrobe system and/or application can provide various details relating to garments associated with a user. For example, the digital wardrobe application can display a listing of all garments, garment metadata (e.g., garment color, size, type), and combinations of outfits that correspond with a ruleset (e.g., providing matching outfits), a usage of the garments, garment environmental ratings, garment resale values, etc. In some instance, information relating to a selected garment (e.g., a garment recently purchased, a garment proposed as being purchased, or a garment otherwise selected by the user) can be processed to show various aspects relating to the garment as described herein. The digital wardrobe application can perform various processes, such as to determine a number of outfits for the selected garment that correspond with a ruleset, deriving an environmental rating of the selected garment, determining a usage of the selected garment, deriving a resale value of the garment, etc. While a “garment” is described as an exemplary example, the present embodiments are not limited to only garments and can include shoes, accessories, outerwear, or anything that can be

The digital wardrobe system and/or application can interact with various devices in a system to perform the processes as described herein. For example, the digital wardrobe application executing on the user device and/or a cloud-based series of servers can interact with purchasing platform servers to obtain metadata for a selected garment or interact with third-party servers to obtain information relating to environmental aspects of a garment, usage information of the garment, resale values of the garment, etc.

In some instances, the present embodiments can automatically integrate garment SKU (stock keeping unit), size, style name and image of every new product that the user owns or purchases into a personal, virtual Dynamic Wardrobe. In some instances, the present embodiments can provide an enhanced dynamic shopping information with wardrobe match permutation comprising using unique data set gathered through the system and method as described herein, output the number of incremental outfits that can be created with a potential new purchase based on the items found in an individual's Dynamic Wardrobe cloud and on their individual preferences.

In some instances, the present embodiments can provide a system and method of providing environmental tracking associated with a users' wardrobe: comprising tracking the environmental impact of the items the user is purchasing, and the total environmental impact of the user's Dynamic Wardrobe as described herein.

In some instances, the present embodiments can provide a system and method of providing dynamic and enhanced usage Information, comprising using new or existing sensor technology to understand individual's usage of the clothes in their wardrobe and relay back that information to their Dynamic Wardrobe as described herein.

In some instances, the present embodiments can provide a system and method of providing enhanced resale value information, comprising tracking the real-time, ever-changing resale value of the items the user is purchasing.

In some instances, the digital wardrobe as described herein can be applicable in a computer-implemented environment (e.g., a “metaverse”). For example, the digital wardrobe can create a multi-verse experience for consumers across shopping, wearing, and selling either physical or virtual garments (e.g., computer-generated instantiations of garments either mapping to a real-world garment or a garment designed to be adapted to a virtual avatar). Further, the digital wardrobe can establish best practices and conscious consumer behavior for consumers in both the analog and virtual marketplace.

### System Overview

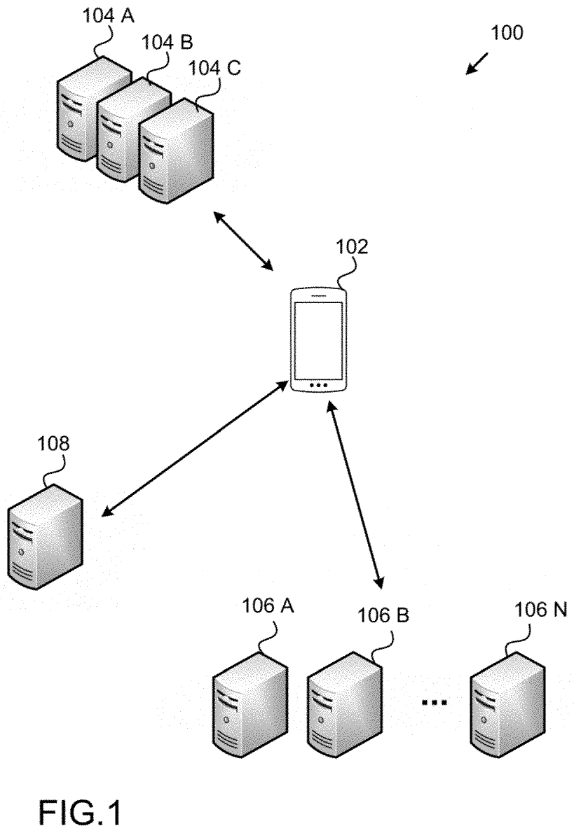

FIG. 1 illustrates an example system 100 for implementing a digital wardrobe application. As shown in FIG. 1, the system 100 can include a user device 102, a series of interconnected servers 104A-C, a series of third-party servers 106A-N, and a purchasing platform server 108. The components in the system 100 can interact via various wired or wireless communication protocols.

The user device 102 can include a device associated with a user. For example, the user device 102 can include a mobile phone, laptop computer, or other electronic device associated with the user. The user device 102 can implement a digital wardrobe application as described herein. For example, the user device 102 can display features relating to a selected garment on the digital wardrobe application. The user device 102 can interact with the series of interconnected servers 104A-C to perform processes and/or store information relating to the digital wardrobe application as described herein. The series of interconnected servers 104A-C can implement a cloud-based system capable of performing processes and/or storing data relating to the digital wardrobe system and/or application.

The third-party servers 106A-N can provide various portions of data to the user device 102 and/or the servers 104A-C. For example, a third-party server can provide metadata relating to a garment, provide environmental data relating to a garment, providing resale values of a garment, etc. The third-party servers 106A-N can include databases, web servers, etc., that can interact with and provide information to the user device 102 and/or the servers 104A-C.

The purchasing server 108 can implement a garment shopping platform and can provide details relating to a selected garment. For example, the purchasing server 108 can provide a stock keeping unit (SKU) for a selected garment (e.g., selected by a user on the shopping platform). The digital wardrobe system and application can obtain the SKU and other metadata for the selected garment and provide details relating to the selected garment as described herein.

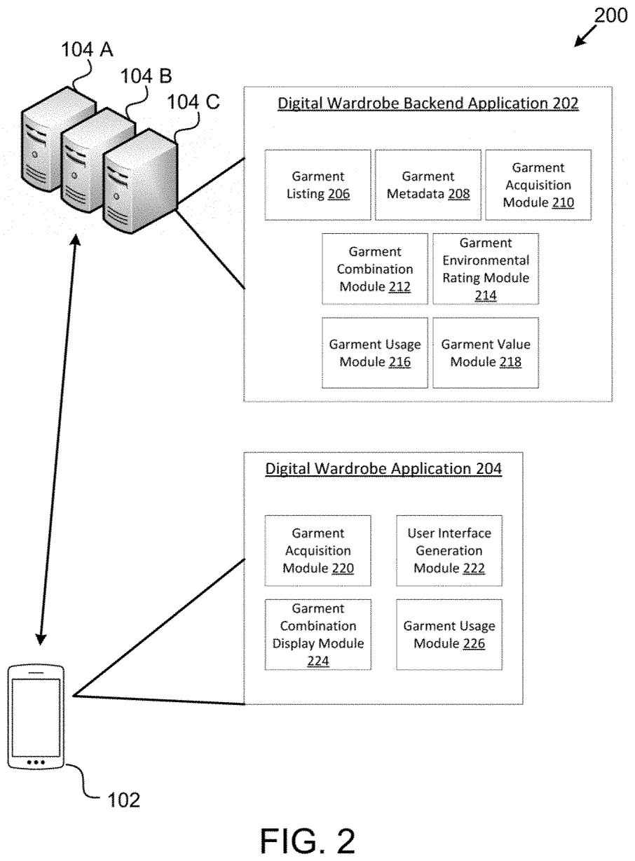

FIG. 2 illustrates an interaction between the user device 102 and the series of interconnected servers 104A-C. As described herein, the user device 102 and the series of interconnected servers 104A-C can perform processes and/or store data relating to the digital wardrobe application.

The user device 102 can implement a digital wardrobe application 204. Further, the servers 104A-C can implement a digital wardrobe backend application 202. The digital wardrobe backend application 202 can implement various functions, such as a garment listing 206. The garment listing 206 can provide an active listing of all garments in the digital wardrobe. For example, as a new garment is added or another garment is removed, the listing of garments can be modified.

The digital wardrobe backend application 202 can also include garment metadata 208. The garment metadata 208 can provide various data relating to each garment, such as a garment type (e.g., shirt, shoes, pants, shorts, outerwear, headwear), a garment color, a garment size, garment material, etc. Garment metadata 208 can be used to derive insights into each garment as described herein.

The digital wardrobe backend application 202 can also include a garment acquisition module 210. The garment acquisition module 210 can onboard a new garment purchased from a shopping platform or otherwise added to the garment listing. For example, as a new garment is added, the new garment can be added to the garment listing 206 and details relating to the garment can be added to garment metadata 208.

The digital wardrobe backend system and application 202 can also include a garment combination module 212. The garment combination module 212 can identify a number of outfit combinations that correspond with a selected garment. For example, the garment combination module 212 can determine each outfit comprising a series of garments from the garment listing that correspond with a ruleset specifying what garments match one another. A selected garment can be shown with each outfit to illustrate each outfit that corresponds with the ruleset. When purchasing a new garment, the digital wardrobe system can calculate the number of incremental outfits that could be generated with the given purchase.

The digital wardrobe backend system and application 202 can also include a garment environmental rating module 214. The garment environmental rating module 214 can obtain environmental information for a selected garment and can derive an environmental rating for the garment. Aspects used for generating the environmental rating can include the materials in the garment, an amount of water used to make the garment, a location of the materials used to make the garment, the pollutants emitted as a result of the garment creation, etc. The environmental rating can provide an insight into an environmental impact of each garment so as to identify garments that are more environmentally friendly, as well as provide the aggregate environmental impact of all the garments found in an individual's wardrobe.

The digital wardrobe backend system and application 202 can also include a garment usage module 216. The garment usage module 216 can track a usage of each garment. For example, each time a garment is worn, the garment can be iteratively tracked as being worn. Usage of each garment can be used in determining outfits or resale value of the garment. In some instances, the user can manually select each garment being worn, while in other instances, the garments can automatically be detected as being worn using sensors or image sensors, for example.

The digital wardrobe backend system and application 202 can also include a garment value module 218. The garment value module 218 can obtain garment values for similar values on third party websites or shopping platforms and assign similar values or value ranges for each garment. The digital wardrobe system can also take into account the amount of usage and the length of ownership to determine re-sale value.

At the user device 102, a digital wardrobe system application 204 can be provided. The digital wardrobe application 204 can include a garment acquisition module 220 that can interact with garment acquisition module 210 to add a new garment. The digital wardrobe application 204 can also include a user interface generation module 222 can provide display of the digital wardrobe application on the user device. The digital wardrobe application 204 can also include a garment combination display module 224 that can interact with module 212 to display various outfits that correspond with a selected garment. The digital wardrobe application 204 can also include a garment usage module 226 that can interact with module 216 and allow for tracking usage of each garment.

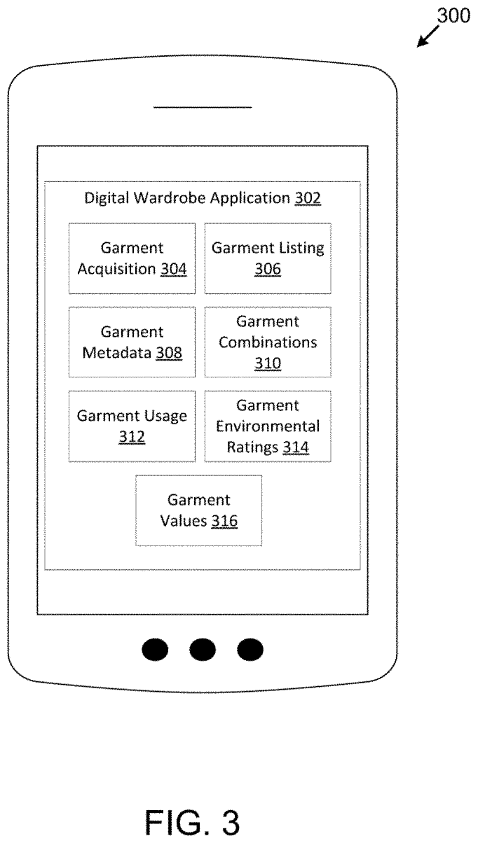

FIG. 3 illustrates an example user interface 300 of a user device. As shown in FIG. 3, the user interface can display a digital wardrobe application 302. The user can interact with the application 302 to view various features of the application 302 and modify aspects of the application as described herein.

For instance, the application 302 can display garment acquisition data 304 that can allow a user to shop for a garment on a third-party shopping platform, purchase a garment, or otherwise add a garment to the garment listing. The application 302 can also include a garment listing 306 that can allow the user to view and interact with various garments in the listing 306.

The application 302 can further display garment metadata 308, such as a garment type, color, and/or an image of the garment, for example. The application 302 can also display garment combinations 310 (or outfits) for a selected garment and a usage 312 of each selected garment. The application can also display garment environmental ratings 314 and garment values 316 for each selected garment.

### Garment Acquisition Process Overview

As described above, a new garment can be added to the digital wardrobe system and/or application. The new garment can be manually added by a user or purchased via a shopping platform as described herein. In some instances, a new garment can be previewed prior to being added to the garment listing as described herein.

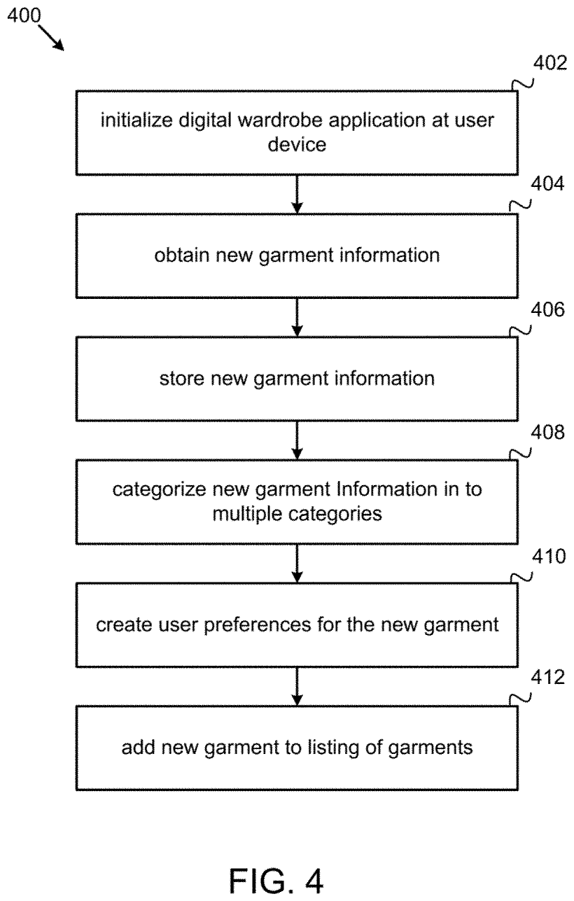

FIG. 4 is a flow process 400 for adding a new garment to a listing of garments. At 402, the method can include initializing a digital wardrobe application at the user device. For instance, the user can select the digital wardrobe application on the user device.

At 404, the method can include obtaining new garment information. This can include automatically integrating a garment SKU, size, style, name, and image of every new product that the user owns or purchases into the application. Each time that a user makes an online or in store purchase, the product information can be integrated into the user's wardrobe cloud via the sale confirmation email. The data associated with the product includes, but is not limited to: SKU, size, style name, material, and an image that is readily available through the purchase confirmation email and is searchable on search engines on the public domain.

In a first embodiment of the present disclosure, a user is able to give access to their online purchases to the Dynamic Wardrobe. The Dynamic Wardrobe can integrate the data associated with the given item and upload it into the virtual wardrobe “cloud,” thus storing the information in its memory.

At 406, the method can include storing the new garment information. The information can be stored at either the user device and/or a cloud-based set of servers.

At 408, the method can include categorizing the new garment information into multiple categories. For example, categories for a new garment can include a garment type, style, seasonality, color, etc. The categories can be used to match the new garment to outfits as described herein.

At 410, the method can include creating user preferences for the new garment. The user can be able to integrate personal information into their user profile including but not limited to age (dynamic input), location (dynamic input), size and height. The user can integrate personal preferences into their use profile such as but not limited to texture, style (brand and trend) and budget. The method and system can gather data through the above steps, to be interpreted by artificial intelligence (AI) that will learn the user's shopping patterns, style, and likes/dislikes that only the user can see. The user preferences can further define outfits that are presented to the user or other actions as described herein.

At 412, the method can include adding the new garment to the listing of garments. This process can be repeated for each newly added or selected garment.

### Garment Combination Overview

In another aspect of the present embodiments, enhanced dynamic shopping information with wardrobe match permutation is described. Using unique data set gathered through the process described herein, and the present system can output the number of incremental outfits that can be created with a potential new purchase, based on the items found in an individual's digital wardrobe cloud and on their individual preferences. The application can take the number of existing items in the virtual wardrobe cloud to calculate how many potential new outfits could be created with the purchase of a single new item of clothing using a permutation algorithm.

For example, an individual is looking to purchase a new blouse. In this example, the individual owns 15 pants and 12 shoes, all of which are uploaded to their virtual wardrobe. The system can be programmed to know that at least 1 pants and 1 pair of shoes would be required to complete a full outfit to compliment the top (not including potential accessory options). When the individual shops online, the disclosed system can display the number of new potential outfits that could be put together for each potential new blouse. In the case of the first blouse, the individual has 10 pants options and 6 shoe options that would match* the shirt. This blouse would thus produce a total of 60 incremental outfits (10 pants×6 shoes×1 shirt=60 new outfits). This information can help the individual optimize their decision based not only on his/her individual preferences but also on which blouse will maximize his/her outfit options in the future.

In another embodiment, the method can rank new shopping alternatives on retailer websites based on number of matches above, personal preferences and brand preferences (similar brands), size & fit learned through the data presented as described above, as well as value and sustainability (as described more below).

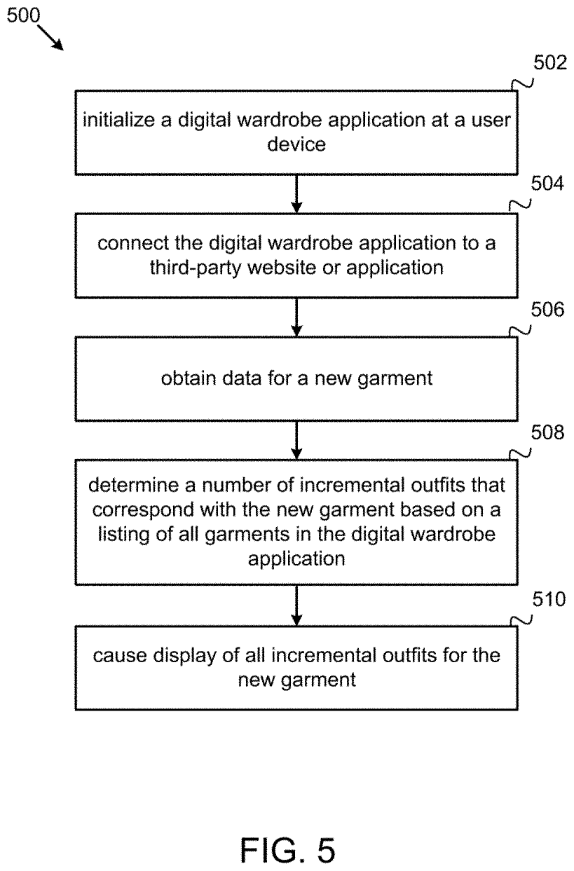

As described above, a new garment can be added responsive to purchase of the garment on a shopping platform. Further, the new garment can be matched with a number of combinations of garments that match (or correspond with a ruleset). FIG. 5 is a flow process 500 for determining a number of incremental outfits for a new garment.

At 502, the method can include initializing the digital wardrobe application at a user device. The user can initialize the application at the user device to add the new garment to the digital wardrobe application.

At 504, the method can include connecting the wardrobe application to a third-party website or application. For example, the application can connect to a shopping platform to obtain data relating to a new garment purchased at the shopping platform.

At 506, the method can include obtaining data for the new garment. The data can include the metadata relating to the new garment for use in categorizing the new garment as described herein.

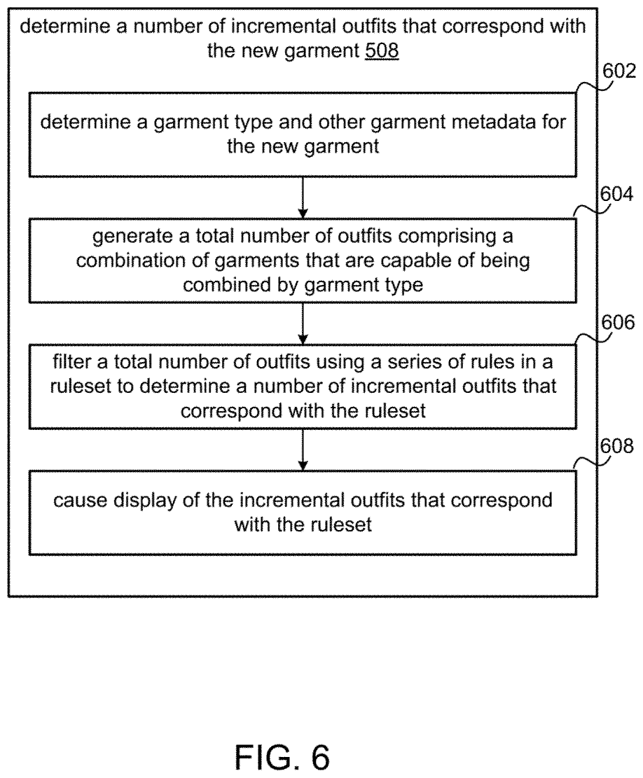

At 508, the method can include determining a number of incremental outfits that correspond with the new garment based on a listing of all garments in the digital wardrobe application. This can include processing each garment through one or more rulesets to determine a number of outfits that correspond with the ruleset. For example, if a new garment is a shirt, the ruleset can determine a number of combinations of garments that match the shirt. For example, an outfit can include a set of a pair of shorts, a pair of shoes, and one or more accessories that match the selected shirt. Determining the number of incremental outfits is described in greater detail with respect to FIG. 6.

At 510, the method can include causing display of all incremental outfits for the new garment. The user can review and select more detail relating to an outfit specific to the new garment.

FIG. 6 illustrates a flow process for determining a number of incremental outfits that correspond with the new garment 508. At 602, the method can include determining a garment type and other garment metadata for the new garment. For example, for a selected garment, a garment type (e.g., a shirt), a garment style (e.g., vintage), a garment color (e.g., black) can be identified for the garment.

At 604, the method can include generating a total number of outfits comprising a combination of garments that are capable of being combined by garment type. The application can construct a total number of outfits capable of being combined with the selected garment. For example, in a garment listing including three shirts, two pairs of pants, and three pairs of shoes, for a new shirt being selected, there are six total possible combinations of outfits for the shirt (assuming an outfit consists of one shirt, one pair of pants, and one pair of shoes).

The total number of possible outfits can be derived via a ruleset. The ruleset can include a series of rules for generating outfits and identify outfits that match. For example, a rule can specify what an outfit can comprise, such as a combination of a shirt, pants, shoes, and one or more accessories. The ruleset can further define what matches in an outfit, based on color of the outfit or a style of each garment.

In some instances, the ruleset can specify rules relating to color, materials, sustainability footprint, and/or reference cost. For example, rules for color can identify matching colors, patterns, etc. for garment. Further, material-based rules can specify matching materials (e.g., Denim, cotton, leather). Rules for a sustainability footprint can specify garment with a threshold environmental rating as generated herein. Rules for reference cost can specify ranges of resale values for garments.

At 606, the method can include filtering the total number of outfits using a series of rules in a ruleset to determine a number of incremental outfits that correspond with the ruleset. The incremental outfits can include a subset of the total amount of outfits that match or comprise a common style. For example, a rule can indicate that a black shirt does not combine with a blue pair of pants, so any outfits comprising such color types are not to be included in the incremental outfits. As another example, a rule can indicate that all garments need to include a common garment style (e.g., vintage, winterwear). In this example, a shirt with a vintage garment style is not to be combined with a modern pair of shoes, and the incremental outfits will not include such a combination.

At 608, the method can include causing display of the incremental outfits that correspond with the ruleset. The user can review the incremental outfits and select an outfit for use by the user.

### Garment Environmental Rating Overview

In another aspect of the present embodiments, the system and method can track the environmental impact of the items the user is purchasing and the total environmental impact of the digital wardrobe.

For instance, the digital wardrobe application can make available information relating to the environmental impact of each garment of clothing by taking into account, for example: 1) the average environmental footprint of the type of garment, and 2) the average lifetime of the type of clothing.

For instance, one pair of jeans can use up to 8 gallons of water. The present embodiments can tap into such research as well as other information related to the location of production, and thus miles traveled, to calculate the average environmental impact of a given item of clothing based on the average usage of water, use of toxic chemicals and dies in clothing, and CO₂ emission based on shipping distance.

Further, the lifespan of clothing significantly determines the environmental impact of a garment. For example, some fast fashion garments are made to last no more than 10 uses. The present embodiments can use such research as well as usage data gathered in 800 to determine the lifespan of a given item of clothing.

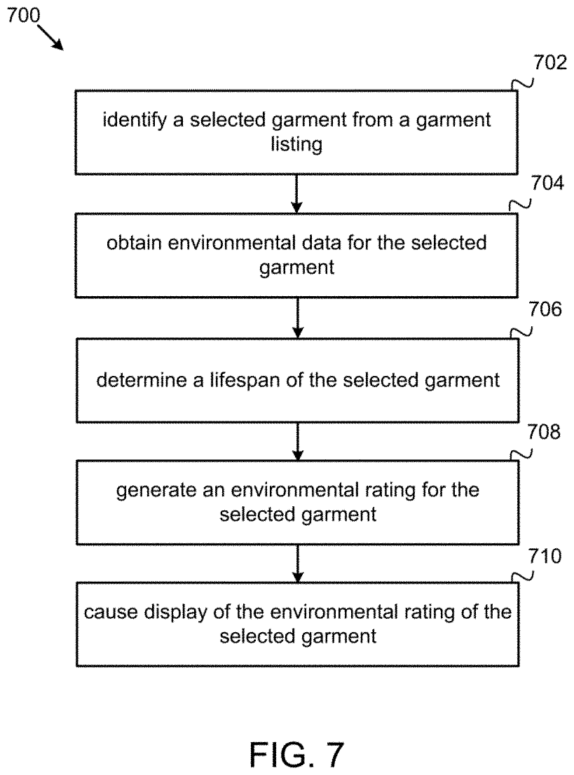

FIG. 7 is a flow process 700 for generating an environmental rating for a selected garment. At 702, the method can include identifying a selected garment from a garment listing. For example, the user can select a garment on a user device.

At 704, the method can include obtaining environmental data for the selected garment. This can include retrieving data relating to the selected garment from one or more third party servers relating to environmental aspects of the garment. The environmental data can include a type of material used to make the garment, a location of the manufacturing of the garment, a type of labor used to make the garment, an amount of water used to make the garment, an amount of Co2 emitted in making the garment, etc.

At 706, the method can include determining a lifespan on the selected garment. The lifespan on the garment can impact the environmental rating due to an ability to use the garment for a longer period of time thus spreading out the environmental impact of the given garment over a longer period of time and reducing the aggregate environmental impact of the individual's wardrobe. Garment usability at 800 can be used to inform such data.

At 708, the method can include generating an environmental rating for the selected garment. The environmental rating can include a score that combines the environment data and/or the lifespan of the garment. For example, a higher score can be indicative of the better (or worse) the garment is for the environment. For instance, as more water is required to produce a garment, the score can increase. Further, if a material is synthetic and uses polluting materials, the environmental score can increase. In some instances, a longer lifespan of the garment can lower the score, given that a longer lifespan can reduce the need to replace the garment.

At 710, the method can include causing display of the environmental rating of the selected garment. The rating can be shown with a garment to illustrate an environmental impact of a potential garment prior to purchasing the garment (or a new garment otherwise acquired by the user).

In some instances, the environmental rating, the resale value range, or other data relating to a garment can be generated for garments selected by the user as the user shops on one or more online shopping platforms. The data described herein can be displayed on either the digital wardrobe application or overlayed on a third-party application (e.g., an online shopping platform).

### Garment Usage Overview

In another aspect, the present embodiments can use sensors to understand usage of the clothes in their wardrobe and relay back that information to the digital wardrobe application. In one embodiment, the system senses movement in the wardrobe using nanotechnology to gather and interpret data on the usage rates of each garment found in the user's wardrobe.

In a first embodiment of the present disclosure, the digital wardrobe system and application can associate each online purchase SKU stored in its memory to a specific sensor. The digital wardrobe application can track the usage rates of the given garment and display the information to the user.

The user can be able to interpret the garment usage information to either: 1) get reminders to use clothes they haven't been using, 2) get recommendations on how to match clothes they haven't been using rid of the clothes they aren't using, or 3) get recommendations on which clothes to get rid of or re-sell (in this case, the process will flow into claim 5 described below). Through this information, the user can be able to optimize their wardrobe by increasing the usage rates of each item or eliminating garments that they do not use.

In some instances, the digital wardrobe system and application can use among others, block-chain, spectral recognition and nanotechnology that is focused on anti-stain, heat and odor purposes, to determine the usability of garments found in a user's wardrobe.

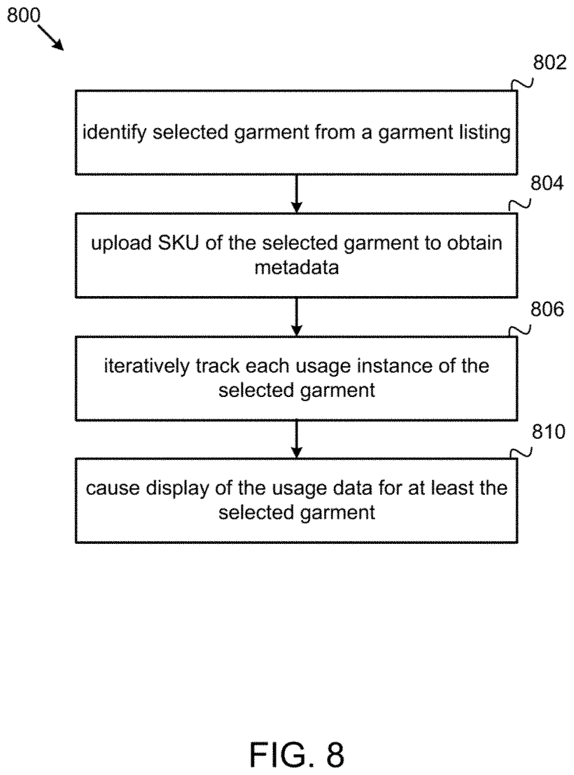

FIG. 8 is a flow process 800 for generating usage data for the garment. At 802, the method can include identifying a selected garment from a garment listing. The selected garment can have stored associated metadata, which can include a counter tracking a number of uses of the selected garment. Each time the garment is used, the counter can be modified to account for the new use of the garment.

At 804, the method can include uploading the SKU for the selected garment to obtain metadata for the selected garment. For instance, the SKU can provide information relating to the type of garment, a garment color, a garment style, a seasonality for the garment (e.g., summer, winter, beachwear), etc.

At 806, the method can include iteratively tracking each usage instance of the selected garment. In some instances, the user can specify all garments being worn by interacting with the application. Alternatively, sensors can track the use of the garments. For example, sensors can be connected to a garment or a hanger hanging the garment, which can be used to detect when the garment is removed and worn by the user. Other embodiments can include an image sensor or camera detecting the wearing of the garment, or a tracking sensor detecting the garment is being worn outside of the wardrobe, for example.

At 808, the method can include causing display of the usage data for at least the selected garment. The usage of each garment can be provided to identify what garments are most commonly worn by the user.

### Resale Value Range Overview

In yet another aspect of the present embodiments, the digital wardrobe system and application can track the real-time, ever-changing resale value of the items the user is purchasing. In some embodiments, the present embodiments can: 1) assess the potential resale value of an item the user is considering purchasing, and 2) assess the potential resale value of an item the user currently owns. The application can: 1) inform purchasing decisions, and 2) extend the lifetime of an item of clothing by reselling an item they no longer use. In other embodiments, the present embodiments can track like-as sales executed in the market to provide real-time information about how much an item of clothing could be re-sold for.

The resale value of an item can be dependent on several factors, including but not limited to: 1) the period of time an item has been held for, 2) how many seasons ago the item was purchased, 3) whether an item bas been worn and how much, and 4) changing fashion trends. When reselling an owned item, the present application can tap into the purchase and usage rate information gathered above to determine the aforementioned factors.

When calculating the future resale value of a purchase consideration, the system and method can tap into the open web to determine the product demand and changing fashion trends that affect the resale value of an item.

In some instances, the present embodiments can use algorithms and AI to calculate the resale value of an item, providing information if the item is re-sold instantly, in 6 months, or 1+ years after purchase.

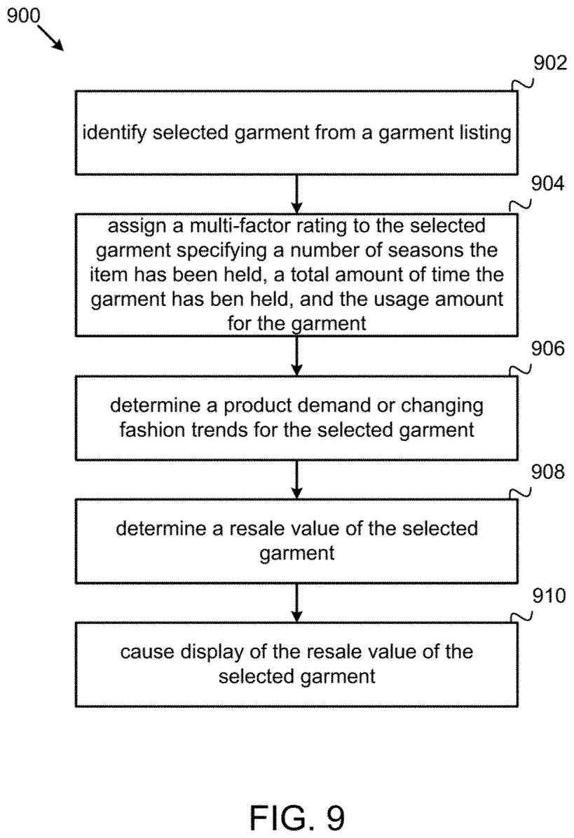

FIG. 9 illustrates an example flow process 900 for generating a resale value range for the selected garment. At 902, the method can include identifying the selected garment from the garment listing.

At 904, the method can include assigning a multi-factor rating for the selected garment specifying a number of seasons that item has been held, a total amount of time the garment has been held, and the usage amount for the garment. This information can be stored as part of the garment metadata and used for determining a resale value of the garment. For instance, in most cases, the longer the garment is held or the more the garment is used, the older or more worn the garment is, the value of the garment is reduced.

At 906, the method can include determining a product demand or changing fashion trends for the selected garment. In some instances, the application can retrieve third party server data relating to fashion trends and product demand for garments similar to a selected garment. For example, for a pair of boots with a specific brand, the third-party data can specify a demand for similar boots (e.g., how many boots are being sold, are the boots sold out on online marketplaces) or an amount of web-based articles that identify the style of boots as being discussed (e.g., and being in accordance with fashion trends). This information can also be used in determining the resale value of the garment.

At 908, the method can include determining a resale value of the selected garment. The resale value can include a range of values identifying a likely resale value of the garment. In some instances, the third-party data can be derived from one or more listed prices for similar garments on online marketplaces.

In some instances, the application can incorporate one or more algorithms to derive a resale value of the garment. For example, the algorithm can take into account the original price of the garment, the garment type, a number of seasons of use of the garment, a number of times that garment was worn, fashion trends, product demand, etc. The algorithm can produce a range of resale values that take into account the specific characteristics of the garment.

At 910, the method can include causing display of the resale value of the selected garment. The resale value range of the garment can be used by the user to take into account actions that can be taken with the garment, such as to sell the garment, for example. Method for Implementing a Digital Wardrobe Application

As described above, the present embodiments can provide relevant information and dynamic guidance on what to buy, wear and sell, taking into consideration: personal and learned preferences, owned articles of clothing, environmental footprint, usage rates of their clothes, and the short and mid and term value of garments. Furthermore, the above-mentioned elements can gather data to be interpreted by the disclosed system that begins to understand the user's style preferences, shopping patterns, lifestyle, spending, and environmental impact that only the user can see. Through this information, individuals can be able to improve their decision making on what to buy, wear and sell, thereby maintaining the contents of the wardrobe optimized in a dynamic manner.

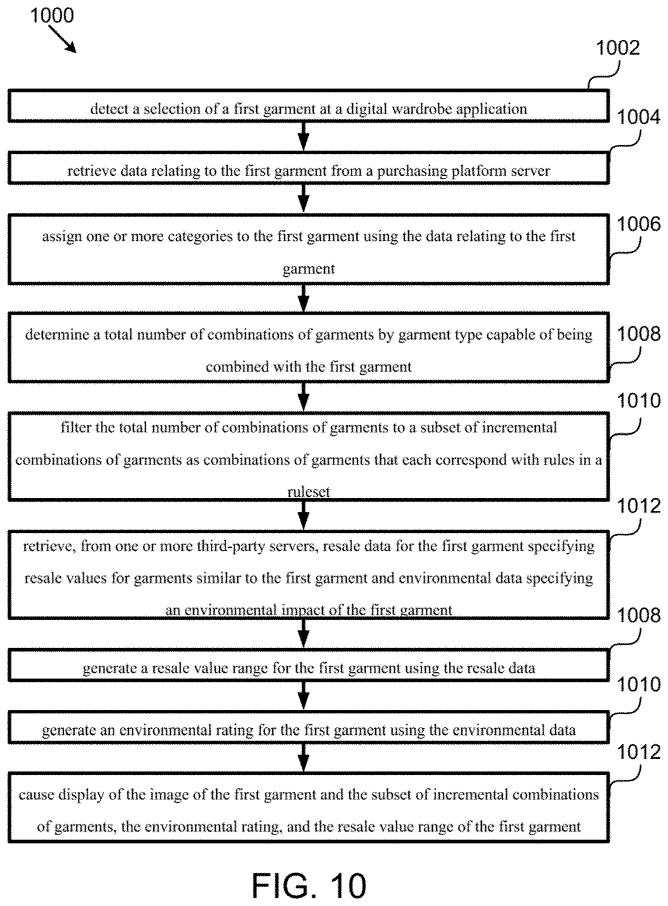

FIG. 10 is a flow process for an example method 1000 for implementing a digital wardrobe application. The method 1000 can be performed by any of a user device interacting with one or more other computing nodes as described herein. In some instances, the user device can interact with a cloud-based system to perform processing and storing data as described herein.

At 1002, the method can include detecting a selection of a first garment at a digital wardrobe application. For example, a user can interact with the digital wardrobe application on a user device to select a garment. The garment can be already owned by the user, identified by the user on an online shopping platform, or recently purchased by the user online.

At 1004, the method can include retrieving data relating to the first garment from a purchasing platform server. The data relating to the first garment can include any of a garment type, a garment color, and an image of the first garment. In some instances, the application can request the SKU of the garment from a purchasing platform server and obtaining the metadata from the purchasing platform server.

At 1006, the method can include assigning one or more categories to the first garment using the data relating to the first garment, the one or more categories categorizing the first garment at least by garment type. For example, a garment type category can assign the garment as a shirt, pant, pair of shoes, outerwear, accessories, glasses, hats, watches, etc. Each garment can be grouped into a garment type category. Further, other categories can be used to categorize garments, such as by seasonality (e.g., summer, winter, fall), activity (e.g., beachwear, snow weather), style (e.g., modern, vintage), etc.

At 1008, the method can include determining a total number of combinations of garments by garment type capable of being combined with the first garment. For example, if the selected garment is a shirt, the total number of combinations of garments can include all possible outfits comprising different garments. For instance, a selected garment comprising a shirt can have a first combination of garments comprising the shirt, a pair of pants, and a pair of shoes (e.g., each garment having a different garment type). Each possible garment combination can be generated by garment type to generate a total number of possible outfits for the first garment.

At 1010, the method can include filtering the total number of combinations of garments to a subset of incremental combinations of garments as combinations of garments that each correspond with rules in a ruleset. The ruleset can include a series of rules permitting garments that can be combined to one another. For example, a rule can specify colors of garments that are allowed to be included in an outfit (e.g., a red shirt cannot be combined with blue pants). Another example of a rule can specify that garment styles are to match (e.g., a shirt with a beachwear style is to be combined only with shoes that have a beachwear style).

In some instances, the rules in the ruleset specify garment color categories of each garment type that are permitted to be combined. The resulting number of outfits that correspond with the ruleset can be filtered to result in only a portion of the outfits being displayed to the user.

At 1012, the method can include retrieving, from one or more third-party servers, resale data for the first garment specifying resale values for garments similar to the first garment and environmental data specifying an environmental impact of the first garment. The third-party servers can provide various sources of information, such as web-based articles, database information, etc.

At 1014, the method can include generating a resale value range for the first garment using the resale data. The resale value can be generated based on retrieved resale values of similar garments on online marketplaces. In some instances, other factors, such as a year the garment was made, an amount of use of the garment, etc., can be incorporated in the derivation of the resale value range.

At 1016, the method can include generate an environmental rating for the first garment using the environmental data. The environmental data can specify a listing of materials in the first garment, an amount of water used in producing the first garment, an amount of pollutants emitted in producing the first garment, and a lifespan of the first garment. The environmental data can be combined to generate the environmental rating indicating how environmentally friendly the garment is.

In some instances, a usage of the first garment can be tracked to identify each instance that the first garment is identified as being worn. The usage of the first garment can be displayed on the digital wardrobe application. In some instances, tracking the usage of the first garment can include receiving, by a sensor disposed within a wardrobe, an indication that the first garment is being worn, and wherein the usage of the first garment can be modified to account for the use of the first garment responsive to receiving the indication from the sensor that the first garment is being worn.

At 1018, the method can include cause display of the image of the first garment and the subset of incremental combinations of garments, the environmental rating, and the resale value range of the first garment.

In some instances, the method can include causing display of an image of a first incremental combinations of garments of the subset of incremental combinations of garments. The user can review the first outfit that includes the first garment for review by the user. The method can also include detecting a selection to view a second incremental combinations of garments. For instance, the user can select another matching outfit to view on the user device. The method can also include causing display of an image of the second incremental combinations of garments of the incremental combinations of garments.

In another example embodiment, a computer-implemented method to implement a digital wardrobe application is provided. The method can include detecting a selection of a first garment at the digital wardrobe application.

The method can also include retrieving data relating to the first garment from a third-party server. The data relating to the first garment can include any of a garment type, a garment color, and an image of the first garment.

In some instances, the retrieving of the data relating to the first garment further includes: transmitting a request to a purchasing platform server requesting the data relating to the first garment, and receiving, from the purchasing platform server, the data relating to the first garment.

The method can also include assigning one or more categories to the first garment using the data relating to the first garment. The one or more categories can categorize the first garment at least by garment type.

The method can also include determining a total number of combinations of garments by garment type capable of being combined with the first garment.

The method can also include filtering the total number of combinations of garments to a subset of incremental combinations of garments as combinations of garments that each correspond with rules in a ruleset.

In some instances, the rules in the ruleset specify garment color categories of each garment type that are permitted to be combined. In some instances, the method further comprises retrieving, from one or more third-party servers, environmental data relating to the first garment. The environmental data can specify a listing of materials in the first garment, an amount of water used in producing the first garment, an amount of pollutants emitted in producing the first garment, and a lifespan of the first garment. The method can also include generating an environmental rating for the first garment and causing display of the environmental rating.

In some instances, the method further comprises tracking a usage of the first garment comprising each instance that the first garment is identified as being worn and causing display of the usage of the first garment. In some instances, tracking the usage of the first garment comprises receiving, by a sensor disposed within a wardrobe, an indication that the first garment is being worn. The usage of the first garment can be modified to account for the use of the first garment responsive to receiving the indication from the sensor that the first garment is being worn.

In some instances, the method further comprises retrieving, from one or more third-party servers, resale data for the first garment specifying resale values for garments similar to the first garment, generating a resale value range for the first garment, and causing display of the resale value range. In some instances, the method further comprises storing the data relating to the first garment and/or the one or more categories to the first garment at a cloud-based series of interconnected servers.

The method can also include causing display of the image of the first garment and the subset of incremental combinations of garments. In some instances, the method further comprises causing display of an image of a first incremental combinations of garments of the subset of incremental combinations of garments, detecting a selection to view a second incremental combinations of garments, and causing display of an image of the second incremental combinations of garments of the incremental combinations of garments.

In another example embodiment, a method performed by a user device for implementing a digital wardrobe application is provided. The method can include detecting a selection of a first garment at a digital wardrobe application.

The method can also include retrieving data relating to the first garment from a purchasing platform server, the data relating to the first garment including any of a garment type, a garment color, and an image of the first garment.

The method can also include determining a number of incremental combinations of garments that include the first garment.

In some instances, the method can include assigning one or more categories to the first garment using the data relating to the first garment, the one or more categories categorizing the first garment at least by garment type.

In some instances, the method can include determining a total number of combinations of garments by garment type capable of being combined with the first garment and filtering the total number of combinations of garments to the number of incremental combinations of garments as combinations of garments that each correspond with rules in a ruleset. In some instances, the rules in the ruleset specify garment color categories of each garment type that are permitted to be combined.

In some instances, the method can include tracking a usage of the first garment comprising each instance that the first garment is identified as being worn, wherein tracking the usage of the first garment comprises receiving, by a sensor disposed within a wardrobe, an indication that the first garment is being worn, wherein the usage of the first garment is modified to account for the use of the first garment responsive to receiving the indication from the sensor that the first garment is being worn, and causing display of the usage of the first garment.

The method can also include retrieving, from one or more third-party servers, resale data for the first garment specifying resale values for garments similar to the first garment and environmental data specifying an environmental impact of the first garment.

The method can also include generating a resale value range for the first garment using the resale data.

The method can also include generating an environmental rating for the first garment using the environmental data.

The method can also include causing display of the image of the first garment and the subset of incremental combinations of garments, the environmental rating, and the resale value range of the first garment.

### Networked System Examples

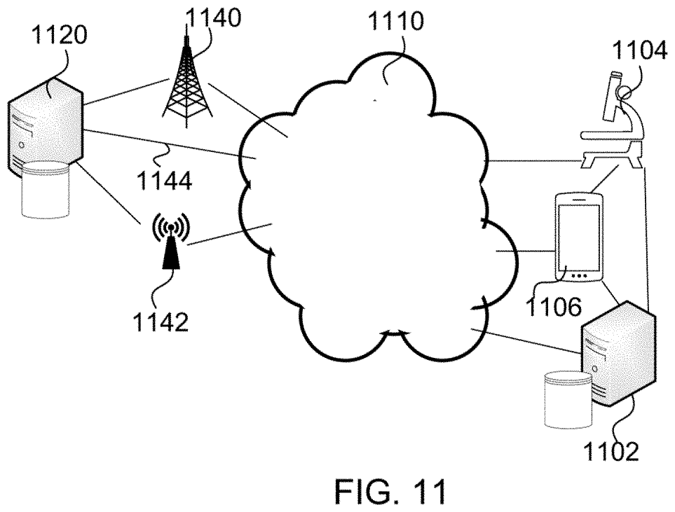

In some examples, as shown in FIG. 11, a computer 1102 with processor and memory is configured to run software. The computer 1102 may be in communication with a network 1110 such as the Internet or local area network. Such computers may include any kind of computer such as but not limited to tablets, smartphones, desktops, laptops, or other computers 1106, and multiple computers may be in communication with one another or run the software as described herein. More detailed and/or further examples of such computers are found in FIG. 11.

Turning back to FIG. 11, the data captured from whichever computer 1102, 1106 may be analyzed on a back end system 1120 instead of or in addition to a local computer. In such examples, data may be transmitted to a back end computer 1120 and associated data storage for saving, analysis, computation, comparison, or other manipulation. In some examples, additionally or alternatively, the transmission of data may be wireless by a cellular 1140 or Wi-Fi 1142 transmission with associated routers and hubs. In some examples, additionally or alternatively, the transmission may be through a wired connection 1144. In some examples, additionally or alternatively, the transmission may be through a network such as the internet 1110 to the back end server computer 1120 and associated data storage. At the back end server computer 1120 and/or local computer systems 1102, 1104 and their respective associated data storage, the spectrometer data, sample identification, sample location, time, date, and/or any other associated test data may be stored, analyzed, compared to previously stored spectrometer data, identification, and/or any other kind of data analysis. In some examples, additionally or alternatively, the data storing, analyzing, and/or processing may be shared between the local computer 1102, 1104 and a back end computing system 1120. In such examples, networked computer resources may allow for more data processing power to be utilized than may be otherwise available at the local computers. In such a way, the processing and/or storage of data may be offloaded to the compute resources that are available. In some examples, additionally or alternatively, the networked computer resources 1120 may be virtual machines in a cloud or distributed infrastructure. In some examples, additionally or alternatively, the networked computer resources 1120 may be spread across many multiple physical or virtual computer resources by a cloud infrastructure. The example of a single computer server 1120 is not intended to be limiting and is only one example of a compute resource that may be utilized by the systems and methods described herein. In some examples, additionally or alternatively, artificial intelligence and/or machine learning may be used to analyze the spectrometer data from the samples. Such systems may employ data sets to train algorithms to help produce better and better results of analysis of samples.

Because the computer systems 1102, 1106 are in communication with the systems 1104, the software running on the computer(s) 1106, 1102 may be used for any number of things including but not limited to, power on the system, open and close the shutter on the is device 1104, continuous spectra collection, calibration for both light and dark, collect spectra, stop collection and save.

### Example Computer Devices

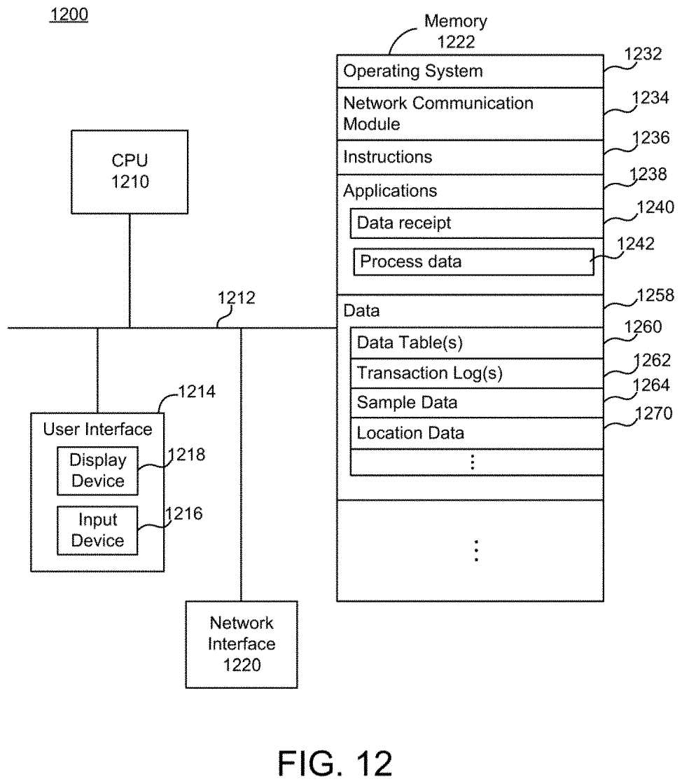

FIG. 12 shows an example computing device 1200 which may be used in the systems and methods described herein. In the example computer 1200 a CPU or processor 1210 is in communication by a bus or other communication 1212 with a user interface 1214. The user interface includes an example input device such as a keyboard, mouse, touchscreen, button, joystick, or other user input device(s). The user interface 1214 also includes a display device 1218 such as a screen. The computing device 1200 shown in FIG. 12 also includes a network interface 1220 which is in communication with the CPU 1220 and other components. The network interface 1220 may allow the computing device 1200 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, additionally or alternatively, the example computing device 1200 includes peripherals 1224 also in communication with the processor 1210. In some examples, additionally or alternatively, peripherals include stage motors 1226 such as electric servo and/or stepper motors used for moving the probe up and down. In some example computing devices 1200, a memory 1222 is in communication with the processor 1210. In some examples, additionally or alternatively, this memory 1222 may include instructions to execute software such as an operating system 1232, network communications module 1234, other instructions 1236, applications 1238, applications to control the spectrometer and/or light source 1240, applications to process data 1242, data storage 1258, data such as data tables 1260, transaction logs 1262, sample data 1264, sample location data 1270 or any other kind of data.

### CONCLUSION

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., H3P, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the description pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a processor, the program code segments combine with the processor to provide a unique device that operates analogously to specific logic circuits.

The software is stored in a machine-readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. A computer-implemented method to implement a digital wardrobe application, the method comprising:
detecting a selection of a any garment at the digital wardrobe application;
retrieving data relating to the first garment from a third-party server, the data relating to the first garment including any of a garment type, a garment color, a garment material, and an image of the first garment;
assigning one or more categories to the first garment using the data relating to the first garment, the one or more categories categorizing the first garment at least by garment type;
storing and causing display of each garment stored by the digital wardrobe application;
determining a total number of combinations of garments by garment type capable of being combined with the first garment;
filtering the total number of combinations of garments to a subset of incremental combinations of garments as combinations of garments that each correspond with rules in a ruleset; and
causing display of the image of the first garment and the subset of incremental combinations of garments.

2. The computer-implemented method of claim 1, wherein the retrieving of the data relating to the first garment further includes:
transmitting a request to a purchasing platform server requesting the data relating to the first garment; and
receiving, from the purchasing platform server, the data relating to the first garment.

3. The computer-implemented method of claim 1, wherein the rules in the ruleset specify garment color, materials, sustainability footprint, and reference cost categories of each garment type that are permitted to be combined.

4. The computer-implemented method of claim 1, further comprising:
retrieving, from one or more third-party servers, environmental data relating to the first garment, the data specifying a listing of materials in the first garment, data specifying a location of production of a given material, an amount of water used in producing the first garment, and/or an amount of pollutants emitted in producing the first garment, and a usage of the first garment;
generating an environmental rating for the first garment; and
causing display of the environmental rating.

5. The computer-implemented method of claim 1, further comprising:
tracking a usage of the first garment comprising each instance that the first garment is identified as being worn; and
causing display of the usage of the first garment.

6. The computer-implemented method of claim 5, wherein tracking the usage of the first garment comprises receiving, by a sensor disposed within a wardrobe or within the first garment, an indication that the first garment is being worn, wherein the usage of the first garment is modified to account for the use of the first garment responsive to receiving the indication from the sensor that the first garment is being worn.

7. The computer-implemented method of claim 1, further comprising:
retrieving, from one or more third-party servers, resale data for the first garment specifying resale values for garments similar to the first garment;
generating a resale value range for the first garment based at least in part on a usage and a time of ownership of the first garment; and
causing display of the resale value range and an aggregate value of all garments stored in the digital wardrobe application.

8. The computer-implemented method of claim 1, further comprising:
storing the data relating to the first garment and/or the one or more categories to the first garment at a cloud-based series of interconnected servers

9. The computer-implemented method of claim 1, further comprising:
causing display of an image of a first incremental combinations of garments of the subset of incremental combinations of garments;
detecting a selection to view a second incremental combinations of garments; and
causing display of an image of the second incremental combinations of garments of the incremental combinations of garments.

10. A user device comprising:
a processor; and
one or more memory nodes comprising instructions that, when executed by the processor, cause the processor to:
detect a selection of a first garment at a digital wardrobe application;
retrieve data relating to the first garment from a purchasing platform server, the data relating to the first garment including any of a garment type, a garment color, and an image of the first garment;
assign one or more categories to the first garment using the data relating to the first garment, the one or more categories categorizing the first garment at least by garment type;
determine a total number of combinations of garments by garment type capable of being combined with the first garment;
filter the total number of combinations of garments to a subset of incremental combinations of garments as combinations of garments that each correspond with rules in a ruleset;
retrieve, from one or more third-party servers, resale data for the first garment specifying resale values for garments similar to the first garment and environmental data specifying an environmental impact of the first garment;
generate a resale value range for the first garment using the resale data;
generate an environmental rating for the first garment using the environmental data; and
cause display of the image of the first garment and the subset of incremental combinations of garments, the environmental rating, and the resale value range of the first garment.

11. The user device of claim 10, wherein the rules in the ruleset specify garment color categories of each garment type that are permitted to be combined.

12. The user device of claim 10, wherein the environmental data specifies a listing of materials in the first garment, an amount of water used in producing the first garment, an amount of pollutants emitted in producing the first garment, and a lifespan of the first garment.

13. The user device of claim 10, wherein the instructions further cause the processor to:
track a usage of the first garment comprising each instance that the first garment is identified as being worn; and
cause display of the usage of the first garment.

14. The user device of claim 13, wherein tracking the usage of the first garment comprises receiving, by a sensor disposed within a wardrobe, an indication that the first garment is being worn, wherein the usage of the first garment is modified to account for the use of the first garment responsive to receiving the indication from the sensor that the first garment is being worn.

15. The user device of claim 10, wherein the instructions further cause the processor to:
cause display of an image of a first incremental combinations of garments of the subset of incremental combinations of garments;
detect a selection to view a second incremental combinations of garments; and
cause display of an image of the second incremental combinations of garments of the incremental combinations of garments.

16. A method performed by a user device for implementing a digital wardrobe application, the method comprising:
detecting a selection of a first garment at the digital wardrobe application;
retrieving data relating to the first garment from a purchasing platform server, the data relating to the first garment including any of a garment type, a garment color, and an image of the first garment;
determining a number incremental combinations of garments that include the first garment;
retrieving, from one or more third-party servers, resale data for the first garment specifying resale values for garments similar to the first garment and environmental data specifying an environmental impact of the first garment;
generating a resale value range for the first garment using the resale data;
generating an environmental rating for the first garment using the environmental data; and
causing display of the image of the first garment and the subset of incremental combinations of garments, the environmental rating, and the resale value range of the first garment.

17. The method of claim 16, further comprising:
assigning one or more categories to the first garment using the data relating to the first garment, the one or more categories categorizing the first garment at least by garment type.

18. The method of claim 17, further comprising:
determining a total number of combinations of garments by garment type capable of being combined with the first garment; and
filtering the total number of combinations of garments to the number of incremental combinations of garments as combinations of garments that each correspond with rules in a ruleset.

19. The method of claim 18, wherein the rules in the ruleset specify garment color categories of each garment type that are permitted to be combined.

20. The method of claim 16, further comprising:
tracking a usage of the first garment comprising each instance that the first garment is identified as being worn, wherein tracking the usage of the first garment comprises receiving, by a sensor disposed within a wardrobe, an indication that the first garment is being worn, wherein the usage of the first garment is modified to account for the use of the first garment responsive to receiving the indication from the sensor that the first garment is being worn; and
causing display of the usage of the first garment.
